(19) United States
(12) Patent Application Publication
(10) Pub. No.: US 2025/0108341 A1
(43) Pub. Date: Apr. 3, 2025

(54) INTERFACIALLY POLYMERISED POLYAMIDE MEMBRANE FOR REVERSE OSMOSIS WITH SILANE ADDITIVE

(71) Applicant: AQUAPORIN A/S, Kgs. Lyngby (DK)

(72) Inventors: Reyhan SENGUR-TASDEMIR, Holte (DK); Torsten Høybye Bak REGUEIRA, Værløse (DK); Brett HOLMBERG, Rungsted Kyst (DK)

(73) Assignee: AQUAPORIN A/S, Kgs. Lyngby (DK)

(21) Appl. No.: 18/730,069

(22) PCT Filed: Jan. 18, 2023
(86) PCT No.: PCT/EP2023/051125

§ 371 Date: Jul. 18, 2024

(30) Foreign Application Priority Data
Jan. 18, 2022 (DK) PA202200047

(51) Int. Cl. B01D 71/56; B01D 61/02; B01D 67/00; B01D 69/02; B01D 69/12

(52) U.S. Cl. CPC B01D 71/56; B01D 61/025; B01D 67/0006; B01D 69/02; B01D 69/1251; B01D 2323/12; B01D 2325/20

(57) ABSTRACT

The present disclosure relates to process for preparing a semi-permeable membrane comprising a porous support membrane and a thin film composite (TFC) layer, comprising providing an aqueous phase comprising a polyfunctional amine monomer, covering a surface of a porous support membrane with the aqueous phase, providing an organic phase comprising a poly functional acy 1 halide monomer and a pore forming agent, covering the aqueous phase with the organic phase and allowing the polyfunctional amine monomer. the polyfunctional acyl halide monomer, and the pore forming agent to perform an interfacial polymerization reaction to form a polyamide TFC layer. The present disclosure further relates to a membrane for water filtration, in particular a membrane for performing forward osmosis (FO), reverse osmosis (RO), or pressure assisted forward osmosis (PAFO), the membrane comprising a polyamide TFC layer.

### TECHNICAL FIELD

The disclosure relates to a membrane for water filtration, in particular a membrane form performing forward osmosis (FO), reverse osmosis (RO), or pressure assisted forward osmosis (PAFO). The disclosure also relates to the production of membrane for water filtration and the use of this membrane for performing a forward osmosis operation.

### BACKGROUND

Reverse osmosis (RO) is generally used to treat water containing dissolved salts. An example of application of the reverse osmosis technology is using seawater or brackish water for producing desalinated potable water. In recent years forward osmosis (FO) has become increasingly popular. In a forward osmosis plant, a feed is typically de-watered to concentrate the feed stream, whereas a draw solution is diluted by the water migrating across the membrane.

The membrane for RO and FO may comprise a support membrane and an active layer attached to the support membrane. Optionally, the membrane may also comprise a third layer, i.e. a bottom layer typically prepared of nonwoven polyester fibers. The active layer determines the membrane properties and performance in terms of flux, solute rejection, and fouling propensity. The active layer is typically a thin film composite (TFC) layer of polyamide. Polyamide TFC layers may be fabricated on the support membrane by interfacial polymerization between diamine in a water phase and acid chloride in inorganic phase. Typically, the diamine is 1,3-phenylenediamine (MPD) and the acid chloride is 1,3,5-benzenetricarbonyl trichloride (TMC).

An efficient membrane desirably has a high water flux and a high solute rejection. However, the two properties typically are mutually exclusive as a tighter membrane with small pores needed for higher solute rejection impedes a high water flux. Therefore, extensive investigation has been focused on the development of membranes that have both a higher degree of water flux and an acceptable solute rejection.

One method to achieve high water flux is to improve monomer diffusivity by adding additives to the water phase, i.e. the diamine solution. For example, adding alcohol and ether in the water phase may lead to higher permeate flux and higher salt rejection. Polyamide membranes prepared by the addition of 20 wt % isopropyl alcohol, showed a high performance with a rejection of 99.7% for 1500 ppm NaCl and water flux of more than 1.7 m³/(m²d) at 1.5 MPa, which is about 1.7-fold higher than that of a membrane prepared without isopropyl alcohol, see U.S. Pat. No. 5,614,099. Lin Zhao, Philip C. -Y. Chang, W. S. Winston Ho, High-flux reverse osmosis membranes incorporated with hydrophilic additives for brackish water desalination, Desalination 308 (2012) 225-232, discloses that adding hydrophilic additives to the water phase led to higher water flux and higher salt rejection. Polyamide membranes prepared by the addition of 2.85 wt % o-aminobenzoic acid with post-treatment by soaking in an aqueous solution of 5 wt % glycerol and 6 wt % CSA-TEA salt followed by drying at 90° C. for 14 min showed the best performance with a rejection of 98.8% for 2000 ppm NaCl and permeate flux of more than 2.1 m³/(m²d) at 1.55 MPa, which was more than twice that of a membrane prepared without hydrophilic additives. W. Xie, G. M. Geise, B. D. Freeman, H. S. Lee, G. Byun, J. E. McGrath, Polyamide interfacial composite membranes prepared from m-phenylene diamine, trimesoyl chloride and a new disulphonated diamine, J. Membr. Sci. 403-404 (2012) 152-161 reported that optimizing the concentrations between diamine and acid chloride led to higher permeate flux and higher salt rejection.

Another method to achieve higher water flux is to add additives to the organic phase. Byeong-Heon Jeong a, Eric M. V. Hoek, Yushan Yan b, Arun Subramani, Xiaofei Huanga, Gil Hurwitz, Asim K. Ghosha, Anna Jawor, Interfacial polymerization of thin film nanocomposites: a new concept for reverse osmosis membranes, J. Membr. Sci. 294 (2007) 1-7, discloses a new membrane concept whereby fabrication was accomplished by adding inorganic nano-sized particles (e.g. zeolite) to an organic phase, which led to higher permeate flux. C. Kong, A. Koushima, T. Kamada, T. Shintani, M. Kanezashi, T. Yoshioka, T. Tsuru, Enhanced performance of inorganic-polyamide nanocomposite membranes prepared by metal alkoxide-assisted interfacial polymerization, J. Membr. Sci. 366 (2011) 382-388, discloses higher permeate flux from organic-inorganic hybrid membranes by adding metal alkoxides to the organic phase. Polyamide membranes prepared by the addition of 5 wt % of phenyltriethoxysilane showed the best performance with a negligible rejection loss. C. Kong, M. Kanezashi, T. Yamamoto, T. Shintani, T. Tsuru, Co-solvent-mediated synthesis of thin polyamide membranes, J. Membr. Sci. 362 (2010) 76-80 and C. Kong, and T. Shintani, T. Kamada, V. Freger, T. Tsuru, Co-solvent-mediated synthesis of thin polyamide membranes, J. Membr. Sci. 384 (2011) 10-16, disclose that the addition of a co-solvent into the organic phase enhanced the miscibility at the interface, and led to high degree of permeate flux using the model type of polyamide, which was an MPD/TMC polyamide without the addition of additives to the water phase. Polyamide membranes prepared by the addition of 2 wt % acetone to the organic phase showed the best performance with a glucose rejection of 99.4% and a water flux of more than 1.4 m³/(m²d) for 500 ppm glucose at 1.5 MPa, which was approximately 4-times higher than that of a membrane prepared without acetone.

Takashi Kamada, Tomomi Ohara, Takuji Shintani, Toshinori Tsuru, Controlled surface morphology of polyamide membranes via the addition of co-solvent for improved permeate flux, Journal of Membrane Science 467 (2014) 303-312, discloses the preparation of polyamide membranes with controlled surface morphology, by interfacial polymerisation in which co-solvents, which included acetone, acetate, diethyl ether, toluene, isopropyl alcohol (IPA) and N,N0-dimethyl formamide (DMF), were added into the organic phase which made it possible to control the surface morphology. Zhaofeng Liu, Guiru Zhu, Yulin Wei, Dapeng Zhang, Lei Jiang, Haizeng Wang and Congjie Gao, Enhanced flux performance of polyamide composite membranes prepared via interfacial polymerization assisted with ethyl formate, Water Science & Technology, 76.7 (2017) 1884-1894, discloses ethyl formate as a co-solvent added in the organic phase.

Zhao Zhang, et al., Tailoring the internal void structure of polyamide films to achieve highly permeable reverse osmosis membranes for water desalination, Journal of Membrane Science 595 (2020) 117518 reports a strategy for developing RO membranes via introduction of the void-tailoring agent 3,3,3-trifluoropropyl trichloro silane (TFPTCS) into the traditional interfacial polymerisation used for forming the thin film composite (TFC) layer on a support membrane. It is noted that the reaction of TFPTCS during the interfacial polymerisation results in increasing pore size and porosity.

SUMMARY 10 It is therefore an object to provide a process for preparing a semi-permeable membrane with improved flux without sacrificing the salt rejection. This technology saves energy for users of membrane modules for e.g., reverse osmosis or forward osmosis. The improved performance of the membrane is 15 obtained by using hitherto unknown pore-forming agents in the organic phase taking part in the interfacial polymerisation. According to a first aspect, there is provided a method for providing a semi-permeable membrane comprising a porous support membrane and a thin film composite (TFC) layer, comprising the steps of: 20 providing an aqueous phase comprising a polyfunctional amine monomer, covering a surface of a porous support membrane with the aqueous phase, 25 providing an organic phase comprising a polyfunctional acyl halide monomer and a pore forming agent selected among the compounds represented by the general formula

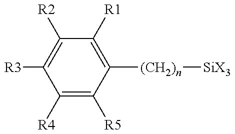

in which
R1, R2, R3, R4, R5 independently are selected from the group comprising H, a straight or branched C₁-C₆ lower alkyl, C₁-C₆ lower alkenyl or C₁-C₆ lower alkynyl, and a halogen selected from the group comprising F, Cl, Br, and I,
n is an integer selected among 0, 1, 2, 3, or 4,
X is a halogen selected among Cl, Br, and I,
covering the aqueous phase with the organic phase and allowing the polyfunctional amine monomer, the polyfunctional acyl halide monomer, and the pore forming agent to perform an interfacial polymerization reaction to form a polyamide TFC layer.

The known compound 3,3,3-trifluoropropyl trichloro silane (TFPTCS) may be used as a reference pore-forming agent and it was surprising for the inventors of the present disclosure to discover that a higher flux can be obtained while the salt rejection remain essentially unaffected by using the pore-forming agents according to the present disclosure. It was also surprising to find that much lower concentrations of TFPTCS than previously disclosed proved to be effective for increasing flux while essentially not affecting salt rejection in pilot scale experiments.

Further implementation forms are apparent from the dependent claims and the description.

Thus, in a possible implementation form of the first aspect, the concentration of pore forming agent in the organic phase is in the range of 0.0001% wt to 0.05% wt. This low concentration may advantageously enable use of a smaller amount of environment damaging compounds, such as fluoride or other halogen containing compounds.

In a possible implementation form of the first aspect, the pore forming agent is represented by the formula:

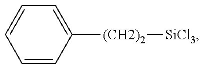

i.e., trichloro (phenethyl) silane (TCPES).

By using TCPES as a pore forming agent, use of environment damaging compounds, such as fluoride or halogen containing compounds may advantageously be avoided.

In a further possible implementation form of the first aspect, the concentration of TCPES in the organic phase is comprised between approximately 0.0001 wt % and 0.001 wt %, such as between approximately 0.00025 wt % and 0.0005 wt %. By using a lower concentration of pore-forming agent a smaller amount potentially expensive compounds may advantageously be used, thus lowering membrane production costs on an industrial scale.

In a possible implementation form of the first aspect, the pore forming agent is represented by the formula:

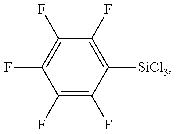

i.e., trichloro [3-(pentafluoro phenyl)] silane (TCPFPS).

In a possible implementation form of the first aspect, the concentration of TCPFPS in the organic phase is comprised between approximately 0.0001 wt % and 0.001 wt %, such as between approximately 0.000125 wt % and 0.0005 wt %.

This low concentration may advantageously enable use of a smaller amount of environment damaging compounds, such as fluoride or other halogen containing compounds.

In a possible implementation form of the first aspect, between approximately 0.1% wt and 0.25% wt acil halide is used.

In a possible implementation form of the first aspect, approximately 0.10% wt, 0.18% wt or 0.21% wt TMC acil halide is used.

In a preferred implementation form of the first aspect, approximately 0.12% wt acil halide is used.

In a preferred implementation form of the first aspect, approximately 0.12% wt acil halide is used in combination with between approximately 0.0001 wt % and 0.001 wt %, such as approximately 0.00025 wt % TCPES. By using said combination, flux may be advantageously increased while maintaining salt rejection of the semi-permeable membrane.

In a preferred implementation form of the first aspect, approximately 0.12% wt acil halide is used in combination with between approximately 0.0001 wt % and 0.001 wt %, such as approximately 0.000125 wt % TCPFPS. By using said combination, flux may be advantageously increased while maintaining salt rejection of the semi-permeable membrane.

In a possible implementation form of the first aspect, the organic phase further comprises a co-solvent selected from the group comprising ethyl formate, ethyl acetate, and diethyl ether.

In a possible implementation form of the first aspect, the concentration of the co-solvent in the organic phase is 0.005 to 5%.

In a possible implementation form of the first aspect, the main solvent of the organic phase comprises linear or branched C₅-C₁₂ alkanes.

In a possible implementation form of the first aspect, the aqueous phase further comprises aquaporins.

In a possible implementation form of the first aspect, the aqueous phase further comprises vesicles having aquaporins incorporated therein.

In a possible implementation form of the first aspect, the vesicles comprise poly-block-(2-methyloxazoline)-poly-block-(dimethylsiloxane) (PMOXA-PDMS).

In a possible implementation form of the first aspect, the vesicles further comprise poly(dimethylsiloxane) as vesicle membrane forming material.

In a further possible implementation form of the first aspect, the poly(dimethylsiloxane) is amine functionalized.

In a possible implementation form of the first aspect, the support membrane comprises polysulfone or a polyethersulfone polymer.

In a possible implementation form of the first aspect, the method further comprises the step of producing a hollow fiber module by assembling a bundle of hollow fibers in a housing, wherein an inlet for passing a first solution is connected to the lumen of the hollow fibers in one end and an outlet is connected to the lumen in the other end, and an inlet is provided in the housing for passing a second solution to an outlet connected to the housing.

In a possible implementation form of the first aspect, the method further comprises the step of producing a spiral wound module by winding the flat sheet membrane.

In a second aspect, a semipermeable membrane is disclosed, which is prepared in accordance with the process disclosed above and in the claims.

In a third aspect, a hollow fiber module is prepared in accordance with the process disclosed above and in the claims.

In a fourth aspect, a spiral wound module is prepared in accordance with the process disclosed above and in the claims.

In a fifth aspect, the use of the hollow fiber module or the spiral wound module according to the above disclosure is provided for preparing a water permeate by reverse osmosis.

In a sixth aspect, the use of the hollow fiber module or the spiral wound membrane module according to the above disclosure is provided for concentration of a product solution by forward osmosis.

In a seventh aspect, a method for preparing a semi-permeable membrane is provided wherein triflouropropyl trichloro silane (TFPTCS) is used as a pore forming agent.

In a possible implementation form of the seventh aspect, the concentration of TFPTCS in the organic phase is in the range of 0.0001% wt to 0.05% wt.

In a preferred implementation form of the seventh aspect, the concentration of TFPTCS in the organic phase is comprised between approximately 0.0001 wt % and 0.001 wt %, such as between approximately 0.00025 wt % and 0.0005 wt %, such as approximately 0.00037 wt %. By using a lower concentration of pore-forming agent a smaller amount potentially expensive and environment threatening compounds may advantageously be used. At a concentration above approsimately 0.0005% wt salt rejection starts to compromise. Thus, a lower concentration is advantageously preferred.

In an eighth aspect, a semi-permaeable membrane is provided, the semi-permeable membrane comprising a porous support membrane and a thin film composite (TFC) layer formed by interfacial polymerization of a polyfunctional amine monomer and a polyfunctional acyl halide monomer in the presence of a pore forming agent selected among the compounds represented by the general formula

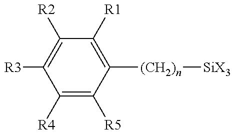

in which
R1, R2, R3, R4, R5 independently are selected from the group comprising H, a straight or branched C₁-C₆ lower alkyl, C₁-C₆ lower alkenyl or C₁-C₆ lower alkynyl, and a halogen selected from the group comprising F, Cl, Br, and I,
n is an integer selected among 0, 1, 2, 3, or 4,
X is a halogen selected among Cl, Br, and I, wherein the polyfunctional amine monomer, the polyfunctional acyl halide monomer, and the pore forming agent form a polyamide thin film composite (TFC) layer.

In a possible implementation form of the eighth aspect, the pore-forming agent is trichloro[3-(pentafluoro phenyl)] pore-forming silane (TCPFPS), trichloro (phenethyl) silane (TCPES), or triflouropropyl trichloro silane (TFPTCS).

In a possible implementation form of the eighth aspect the semi-permeable membrane further comprises aquaporin proteins.

In a further possible implementation form of the eighth aspect, the aquaporin proteins are comprised in vesicles.

In a further possible implementation form of the eighth aspect, the vesicles comprise poly-block-(2-methyloxazoline)-poly-block-(dimethylsiloxane) (PMOXA-PDMS) and, optionally amine functionalized poly(dimethylsiloxane) as vesicle membrane forming material.

### BRIEF DESCRIPTION OF DRAWINGS

In the following detailed portion of the present disclosure, the aspects, embodiments, and implementations will be explained in more detail with reference to the example embodiments shown in the drawings, in which:

FIGS. 1a-c represent the chemical structures of pore-forming analogues according to the disclosure, and

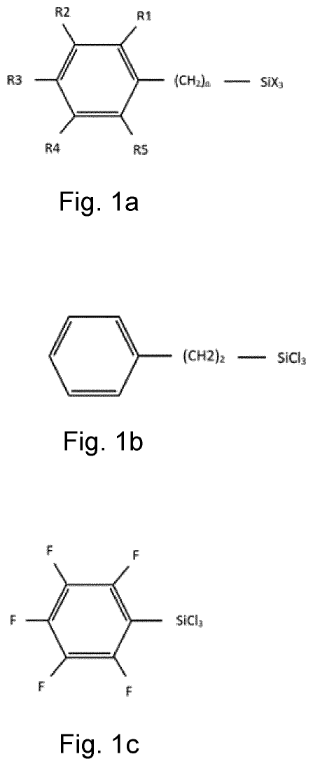

FIG. 2 shows comparative performance results of pore-forming analogues in pilot scale membrane production.

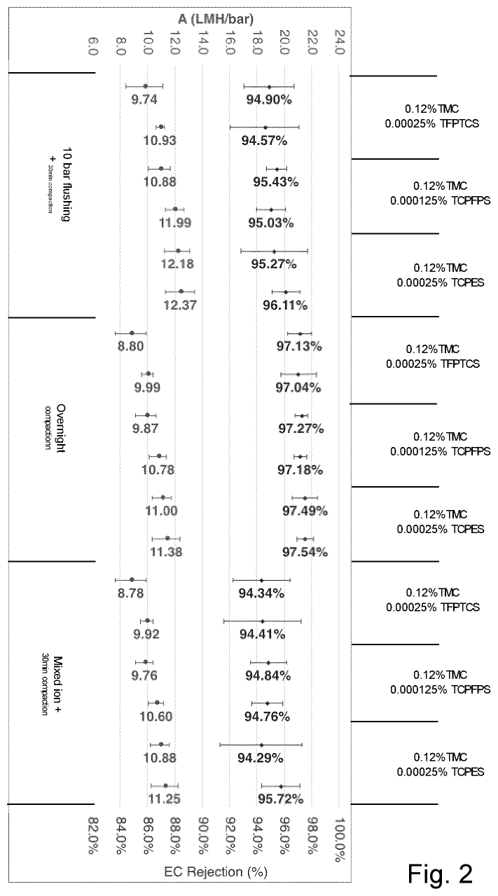

### DETAILED DESCRIPTION

The polyfunctional amine monomer may have primary or secondary amino groups and may be aromatic (e.g., m-phenylenediamine, p-phenylenediamine, 1,3,5-triaminobenzene, 1,3,4-triaminobenzene, 3,5-diaminobenzoic acid, 2,4-diaminotoluene, 2,4-diaminoanisole, and xylylenediamine) or aliphatic (e.g., ethylenediamine, propylenediamine, diethylene triamine, dipropylene triamine, phenylenetriamine, bis(hexamethylene)triamine, bis(hexamethylene)triamine, bis(3-aminopropyl)amine, hexamethylenediamine, N-tallow alkyl dipropylene, 1,3,5-triazine-2,4,6-triamine, and tris(2-diaminoethyl)amine). The polyfunctional amine monomer is suitably a di-or triamine compound. Examples of preferred polyamine species include primary aromatic amines having two or three amino groups, most especially m-phenylene diamine (MPD), and secondary aliphatic amines having two amino groups, most especially piperazine.

The polyfunctional acyl halide monomer is generally a di- or triacyl halide compound, which may be selected among trimesoyl chloride (TMC), trimesoyl bromide, isophthaloyl chloride (IPC), isophthaloyl bromide, terephthaloyl chloride (TPC), terephthaloyl bromide, adipoyl chloride, cyanuric chloride and mixtures of these compounds. The monomeric polyfunctional acyl halide is preferably coated from a non-polar organic solvent, although the polyfunctional acyl halide may be delivered from a vapor phase (for polyacyl halides having sufficient vapor pressure). The polyfunctional acyl halides are preferably aromatic in nature and contain at least two and preferably three acyl halide groups per molecule. Because of their lower cost and greater availability, chlorides are generally preferred over the corresponding bromides or iodides. One preferred polyfunctional acyl is TMC.

A suitable pore forming agent may be selected among the compounds represented by the general formula

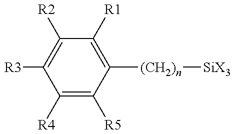

in which
R1, R2, R3, R4, R5 independently are selected from the group comprising H, a straight or branched C₁-C₆ lower alkyl, C₁-C₆ lower alkenyl or C₁-C₆ lower alkynyl, and a halogen selected from the group comprising F, Cl, Br, and I,
n is an integer selected among 0, 1, 2, 3, or 4,
X is a halogen selected among Cl, Br, and I,

When n is 0 a straight line is formed representing a covalent bond between the phenyl group and the silane group.

The main solvent for the organic phase may be selected from a wide group of compounds. Suitable organic solvents are, for example, one or more of the following non-polar solvents such as hydrocarbons, which may be unsubstituted or substituted. Non-polar solvents include aromatic hydrocarbons, for example mono-or polyalkyl-substituted benzenes, such as toluene, xylenes, mesitylene, ethylbenzene, or mono- or polyalkyl-substituted naphthalenes, such as 1-methylnaphthalene, 2-methylnaphthalene or dimethyl naphthalene, or other benzene-derived aromatic hydrocarbons, such as indane, indene or Tetralin or mixtures thereof. Non-polar solvents also include aliphatic hydrocarbons, for example straight-chain aliphatic compounds of the formula CₙH₂ₙ₊₂, in which n=5−12 or branched aliphatics. Suitable examples of straight-chain or branched aliphatic compounds include pentane, hexane, heptane, octane, nonane, decan, undecane, dodecane, 2-methylbutane (iso-pentane), 2,2,4-trimethylpentane (iso-octane), iso-hexane, iso heptane, iso-nonane, iso-dodecane, iso-undecane, (iso-dodecane or combinations thereof. Non-polar aliphatic solvents also include cyclic, optionally alkyl-substituted aliphatics, such as cyclohexane or methyl cyclopentane or mixtures thereof. Non-polar aliphatic solvents are available commercially as the Exxsol® D series, Isopar® series or Bayol® series. A preferred non-polar aliphatic solvent includes Isopar® E, having a distillation range of 115-140° C. and an aromatic content of less than 0.002% by weight. Isopar® E mainly comprises C7 to C10 alkanes. Another suitable non-polar aliphatic solvent is Isopar® C having a distillation range of 99-104° C. and an aromatics content of less than 0.001.

Other organic solvents for consideration include mixtures of aromatic and aliphatic hydrocarbons, such as solvents of the Solvesso® series, for example, Solvesso® 100, Solvesso® 150 or Solvesso® 200 Chemicals); (ExxonMobil of the Solvarex®/Solvaro® series (TotalFinaElf); or the Caromax® series, for example, Caromax® 28 (Petrochem Carless).

After the polyfunctional amine monomer of the aqueous phase has been allowed to react with the polyfunctional acyl halide monomer and the pore-forming agent of the organic phase for the formation of a cross-linked polyamide thin composite layer on the support membrane, the solvents, and optional co-solvents are generally allowed to leave the cross-linked polyamide layer by dissolution, rinsing, or washing.

In a certain embodiment, the solvents and optional co-solvents are removed by maintaining the semi-permeable membrane in a bath for a certain time and then allowing the semi-permeable membrane to dry.

While the membrane is expected to function for any semi-permeable membrane described above and being capable of performing a forward osmosis process, the water flux generally becomes more efficient when aquaporin water channels are incorporated into the TFC layer. Aquaporin water channels are transmembrane proteins widely occurring in nature for selective transportation of water in or out of cells. In an industrial setting, the aquaporin water channels in a semi-permeable membrane ensure the flow of water by osmosis, while other solutes in the solution are rejected. The presence of active aquaporin water channels thus assists the semi-permeable membrane in rejecting solutes and in promoting the penetration of water through the membrane.

The aquaporin water channels are incorporated in the membrane in the active conformation for at least a significant amount of the molecules. According to an aspect of the disclosure, the activity of the aquaporin water channels is maintained when the aquaporin water channels are assembled in a nanostructure comprising polyalkyleneimine, such as polyethyleneimine. As explained in further detail in WO17137361, which is incorporated herein in its entirety, polyalkyleneimine, such as polyethyleneimine (PEI), form self-assembled nanostructures with transmembrane proteins, such as aquaporin water channels. The nanostructures ensure that at least a part of the aquaporin water channels remains active even after incorporation into the TFC layer. It is currently believed that the polymer interacts with the transmembrane protein to prevent it from reacting with monomers participating in the formation of a TFC layer. Furthermore, it is currently believed that the PEI of the aquaporin nanoparticle react with the PAI and thus become integrated in the gutter layer.

Generally, the PEI is a substantially linear or branched polymer having an average molecular weight of between about 2,000 Da to about 10,000 Da, such as between about 3,000 Da to about 5,000 Da. It is currently believed that the relatively short polymer interacts with the transmembrane protein to prevent it from reacting with monomers participating in the formation of a TFC layer, while at the same time not substantially inhibiting the interaction with water.

To prevent aggregation of aquaporin water channels, it may be an advantage to have the aquaporin water channel solubilized in a detergent prior to assembling in a nanostructure comprising polyalkyleneimine. Due to the natural occurrence of the aquaporin water channel in the cell membrane, the protein displays a hydrophobic domain. It is believed that the hydrophobic domain of a detergent interacts with the hydrophobic domain of the aquaporin water channel, thereby forming a solubilized protein. While the aquaporin water channel may be solubilized by a number of detergents, it is currently preferred to use a detergent selected from the group consisting of LDAO, OG, DDM, or a combination thereof.

In another embodiment of the disclosure, the aquaporin water channels are provided in a vesicle prior to the incorporation in the TFC layer. Vesicles are the natural environment for the aquaporin water channels and the vesicles may be formed by a number of different membrane forming materials, including the naturally occurring phospholipids.

In a certain embodiment of the disclosure, the vesicle is formed of an amphiphilic diblock copolymer, such as poly(2-methyloxazoline)-block-poly(dimethyl siloxane) diblock copolymer (PMOXA-PDMS) and a reactive end group functionalized poly(dimethyl siloxane) (PDMS).

The two blocks of the PMOXA-PDMS diblock co-polymer may be of different lengths. To obtain sufficient stability of the vesicle the PMOXA-PDMS diblock co-polymer is typically selected from the group consisting of PMOXA10-40-PDMS25-70 and mixtures thereof. Experiments have shown that a mixture of different PMOXA-PDMS diblock co-polymers shows higher robustness.

In a preferred embodiment, the vesicles, therefore, comprise at least a first amphiphilic diblock copolymer of the general formula PMOXA10-28-PDMS25-70 and a second amphiphilic diblock copolymer of the general formula PMOXA28-40-PDMS25-70. The weight proportion between the first and the second amphiphilic diblock copolymer is usually in the range of 0.1:1 to 1:0.1. The concentration of amphiphilic diblock copolymer in the liquid composition is generally in the range of 0.1 to 50mg/ml, such as 0.5 to 20 mg/ml, and preferably 1 to 10 mg/ml.

The reactive end group functionalised PDMS (reactive end group functionalized poly(dimethyl siloxane)) of the vesicle may be functionalized with one or more of amine, carboxylic acid, and/or hydroxy groups. In a certain aspect of the disclosure the reactive end group functionalised PDMSe-f is bis(amino alkyl), bis(hydroxyalkyl), or bis(carboxylic acid alkyl) terminated PDMSe-f, such as poly(dimethyl siloxane), bis(3-aminopropyl) or poly(dimethyl siloxane), bis(3-hyroxypropyl). Suitably, the integer e is selected in the range of 20 to 40, such as 30 and the integer f is selected from the range of 40 to 80, such as 50. Furthermore, the reactive end group functionalised PDMSe-f may be selected from the group consisting of H2N-PDMS30-50, HOOC-PDMS30-50, and HO-PDMS30-50 and mixtures thereof. Prior to the incorporation of the vesicles with aquaporin water channels, the vesicles may be present in a liquid composition and the amount of PDMS is preferably from about 0.05% to about 1% v/v.

A vesicle according to this disclosure may further contain about 1% v/v to about 12% v/v of triblock copolymer of the PMOXAa-b-PDMSc-d-PMOXAa-b type to increase its integrity. Typically, said vesicle comprises from about 8% v/v to about 12% v/v of triblock copolymer of the PMOXAa-b-PDMSc-d-PMOXAa-b type. The triblock copolymer of the PMOXAa-b-PDMSc-d-PMOXAa-b type is typically selected from PMOXA10-20-PDMS25-70-PMOXA10-20.

A vesicle according to this disclosure may further comprise a flux improving agent to increase either the water flux or decrease the reverse salt flux. The flux improving agent may be selected among a large group of compounds by is generally preferred as alkylene glycol monoalkyl ether alkylate, beta cyclodextrin, or polyethylene glycol (15)-hydroxy stearate. The flux increasing agent is usually present in an amount of 0.1% to 1% by weight of the liquid composition.

A vesicle according to this disclosure may be present in a liquid composition before immobilization in a membrane, such as a TFC layer provided on a support membrane. The liquid composition may comprise a buffer to stabilize the vesicles. Before the aquaporin water channels are mixed with the other constituents, suitably the transmembrane protein is solubilized in a detergent. The vesicles in the liquid composition may further comprise a detergent or a surfactant.

The detergent may be selected from the group consisting of lauryl dimethylamine N-oxide (LDAO), octyl glucoside (OG), dodecyl maltoside (DDM) or combinations thereof.

Without wishing to be bound by any particular theory, it is believed that the vesicles containing free available reactive groups on the surface will be not only physically incorporated or immobilised in (adsorbed), but, in addition, chemically bound in the TFC layer, because the reactive free end groups, such as amino groups, hydroxyl groups and carboxyl groups, will participate in the interfacial polymerization reaction with the acyl chloride, such as a trimesoyl chloride (TMC). In this way, it is believed that vesicles will be covalently bound in the TFC layer, leading to relatively higher vesicle loading and thus higher water flux through the membranes.

Furthermore, it is currently believed that the free end groups, such as amino groups or hydroxyl groups may react with carbonyl groups of the PAI to form a covalent connection between the vesicle and the support hollow fiber membrane. In addition, it is believed that the covalent coupling of vesicles in the TFC layer results in higher stability and/or longevity of the aquaporin water channels and the vesicles containing aquaporin water channels when incorporated in the selective membrane layer.

The vesicles may be prepared in a liquid composition incorporating the aquaporin water channels, comprising the step of stirring a mixture of a solution of an amphiphilic diblock copolymer of the PMOXAa-b-PDMSc-d type, 0.05% to about 1% of reactive end group functionalised PDMSe-f, and aquaporin water channels. To obtain the best result, the stirring is continued for 12-16 hours.

The preparation of a thin film composite layer immobilizing vesicles incorporating the aquaporin water channels on a porous substrate membrane comprises the steps of providing a mixture of vesicles in a liquid composition prepared as disclosed above, and a di-amine or tri-amine compound, covering the surface of a porous support membrane with the mixture, applying a hydrophobic solution comprising an acyl halide compound, and allowing the aqueous solution and the hydrophobic solution to perform an interfacial polymerization reaction to form the thin film composite layer. In a certain embodiment, the hydrophobic solution further comprises a TFC layer modifying agent in an amount of 0.1 to 10% by volume. The TFC layer modifying agent has the purpose to increase the water flow and/or the rejection of solutes.

In a suitable embodiment, the TFC layer modifying agent is a C3 to C8 carbonyl compound. As an example, the TFC layer modifying agent is selected among the group consisting of diethylene ketone, 2-pentanone, 5-pentanone, and/or cyclopentanone.

Suitable co-solvents may be chosen among solvents having the general formula R₁-O-R₂. The substituent R₁ may be selected from the group comprising a straight or branched C1-C6 lower alkyl, C1-C6 lower alkenyl or C1-C6 lower alkynyl, optionally substituted with 1 to 3 substituents selected among the groups methyl, ethyl, propyl, flour, chlorine, bromine, iodine, hydroxy, aldehyde, carboxylic acid, amine, amide, nitril, methoxy, ethoxy, propoxy, isopropoxy, and any combination thereof. In particular R₁ may be selected among methyl, ethyl, n-propyl, isopropyl, n-butyl, sec-butyl, isobutyl, tert-butyl, n-pentyl, tert-pentyl, neopentyl, isopentyl, sec-pentyl, 3-pentyl, sec-isopentyl, n-hexyl, isohexyl, 3-methyl pentyl, neohexyl, and 2,3 dimethyl butyl.

The substituent R₂ may be selected from a group comprising a straight or branched C1-C6 lower alkyl, C1-C6 lower alkenyl, C1-C6 lower alkynyl, carbonyl C1-C6 lower alkyl, carbonyl C1-C6 lower alkenyl, carbonyl C1-C6 lower alkynyl, optionally substituted with 1 to 3 substituents selected among the groups methyl, ethyl or propyl, flour, chlorine, bromine, iodine, hydroxy, aldehyde, carboxylic acid, amine, amide, nitril, methoxy, ethoxy, propoxy, isopropoxy, and any combination thereof. In particular R2 may be selected among methyl, ethyl, n-propyl, isopropyl, n-butyl, sec-butyl, isobutyl, tert-butyl, n-pentyl, tert-pentyl, neopentyl, isopentyl, sec-pentyl, 3-pentyl, sec-isopentyl, n-hexyl, isohexyl, 3-methyl pentyl, neohexyl, dimethyl butyl, formyl, acetyl, propionyl, n-butanoyl, isobutanoyl, n-pentanoyl, isopentanoyl, sec-pentanoyl, tert-pentanoyl, n-hexanoyl, isohexanoyl, sec-hexanoyl, 3-methyl pentanoyl, neohexanoyl, and 2,3 dimethyl butanoyl.

Preferred co-solvents include ethyl acetate, diethyl ether, and ethyl formate.

The porous support membrane may be a hollow fiber membrane or a flat sheet membrane. Currently, a flat sheet membrane is suitable and may be used for the production of various modules like plate-and-frame modules or spiral-wound modules.

For the purposes herein the term “semi-permeable membrane” includes selectively permeable membranes and semipermeable membranes for water filtration and water separation, such as asymmetric membranes comprising a porous support membrane having a selective layer formed on one side, such as a thin crosslinked aromatic polyamide layer or. The other side may be reinforced by a woven or non-woven layer or mesh typically made of polyester fibers.

In addition, the semi-permeable membrane according to this disclosure is useful in a method for the concentration of a product solution, said method comprising utilizing a separation membrane according to this disclosure mounted in a filter housing or module to extract water from the product solution, e.g., by forward osmosis.

In an aspect, it includes a hollow fiber (HF) module having a bundle of hollow fiber membranes modified with a selective layer according to this disclosure. Preferably, the selective layer comprises a thin film composite (TFC) layer formed on the inside surface of the fibers through an interfacial polymerization reaction.

The separation membrane according to this disclosure may additionally be useful in a method for the production of salinity power using pressure retarded osmosis, said method comprising utilizing said separation membrane to increase hydrostatic pressure, and using the increase in hydrostatic pressure as a source of salinity power, cf. WO2007/033675 and WO2014128293 (A1).

The term “aquaporin” as used herein includes a functional natural or synthetic aquaporin or aquaglyceroporin water channel, such as aquaporin Z (AqpZ), GlPf, SoPIP2;1, aquaporin 1 and/or aquaporin 2. Aquaporin water channels include bacterial aquaporins and eukaryotic aquaporins, such as yeast aquaporins, plant aquaporins and mammalian aquaporins, as well as related channel proteins, such as aquaglyceroporins. Examples of aquaporins and aquaglyceroporins include: prokaryotic aquaporins such as AqpZ; mammalian aquaporins, such as Aqp1 and Aqp2; plant aquaporins, such as plasma intrinsic proteins (PIP), tonoplast intrinsic proteins (TIP), nodulin intrinsic proteins (NIP), and small intrinsic proteins (SIP), e.g. SoPIP2;1, PttPIP2;5 and PtPIP2; 2; yeast aquaporins, such as AQY1 and AQY2; and aquaglyceroporins, such as GlpF and Yf1054. Aquaporin water channel proteins may be prepared according to the methods described herein or as set out in Karlsson et al. (FEBS Letters 537: 68-72, 2003) or as described in Jensen et al. US 2012/0080377 A1 (e.g. see Example 6).

Examples of semi-permeable membranes are nanofiltration (NF) membranes, forward osmosis (FO) membranes, and reverse osmosis (RO) membranes. Flat sheet TFC membranes are typically made depositing a polyamide layer on top of a polyethersulfone or polysulfone porous layer on top of a non-woven or woven fabric support. The polyamide rejection layer is formed through interfacial polymerization of an aqueous solution of an amine with a solution of an acid chloride in an organic solvent. TFC membranes may be produced as described in WO 2013/043118 (Nanyang Technological University & Aquaporin A/S).

“Thin-film-composite” or (TFC) membranes as used herein may be prepared using a polyfunctional amine reactant, preferably an aromatic amine, such as a diamine or triamine, e.g. 1,3-diaminobenzene (m-Phenylenediamine, >99% pure, available from Sigma-Aldrich) in an aqueous solution, and a polyfunctional acyl halide reactant, such as a di-or triacid chloride, preferably an aromatic acyl halide, e.g. benzene-1,3,5-tricarbonyl chloride (CAS No. 84270-84-8, trimesoyl chloride (TMC) available from Sigma-Aldrich) dissolved in an organic solvent, where said reactants combine in an interfacial condensation polymerization reaction, cf. Khorshidi et al. (2016) Scientific Reports 6, Article number: 22069, and U.S. Pat. No: 4,277,344 which describes in detail the formation of a composite membrane comprising a polyamide laminated to a porous membrane support, at the surface of the porous support membrane, e.g. a polyethersulfone membrane.

Forward osmosis (FO) or direct osmosis is an osmotic process that uses a selective and permeable membrane to effect separation of water from dissolved solutes. The driving force for this separation is an osmotic pressure gradient between a solution of high concentration, herein referred to as the draw and a solution of lower concentration, referred to as the feed. The osmotic pressure gradient induces a net flow of water through the membrane into the draw, thus effectively concentrating the feed. The draw solution can consist of a single or multiple simple salts or can be a substance specifically tailored for forward osmosis applications. The feed solution can be a dilute product stream, such as a beverage, a waste stream or seawater.

Most of the applications of FO, thus fall into three broad categories: product concentration, waste concentration, or production of clean water as a by-product of the concentration process. Membranes according to this disclosure are useful in all types of forward osmosis processes and may be specifically adapted for each forward osmosis type.

The term “reverse osmosis” (RO) as used herein refers to when an applied feed water pressure on a selectively permeable membrane is used to overcome osmotic pressure. Reverse osmosis typically removes many types of dissolved and suspended substances from feed water, including bacteria, and is used in both industrial processes and in the production of potable water. During the RO process, the solute is retained on the pressurized side of the membrane and the pure solvent, the permeate, passes to the other side. Selectivity specifies that the membrane does not allow larger molecules or ions through its pores (holes), while allowing smaller components of the solution (such as solvent molecules) to pass freely. Low pressure reverse osmosis (LPRO) membranes typically operate at a feed water pressure from about <5 bar and up to a maximum operating pressure of about 25 bar 15 specific flux LMH/bar. LPRO performed at the lower feed pressure ranges, e.g. 2 to 5 bar is sometimes designated ultra-low pressure reverse osmosis. LPRO membranes known in the art have typical operating limits for feed water temperature of about 45° C., feed water pH in the range of 2 to 11, and chemical cleaning in the range of pH 1 to 12.

The presently disclosed aspects are further illustrated with reference to the following non-limiting examples:

### EXAMPLES

### 1.1: Production of the Support Membrane

A dope was prepared of 17% polysulfone (Solvay P3500 MB7 LCD) dissolved in 83% DMF (N, N-Dimethylformamide) obtained from TACT Chemie. The dope was mixed at a mixing speed of 90 rpm in a closed container at 45° C. for 8 hours for obtaining a uniform viscosity.

The dope was cast on a non-woven polyester sheet (model PMB-SKC) obtained from Mitsubishi in a knife over roll casting mode using a casting gap of 230 μm. After an exposure time 1.9 s a phase inversion was performed by quenching in water at 13.7° C. for 13s. Subsequently, the support membrane was washed in water at 60° C. for 1.75 mins. A thickness of about 130 μm was obtained.

### 1.2: Production of Aquaporin Water Channel

Expression of histidine tagged aquaporin from Oryza sativa Japonica (Japanese Rice) in Escherichia coli and its purification using immobilized metal affinity chromatography (IMAC)

The gene encoding aquaporin from Oryza sativa Japonica (UNIPROT: A3C132) was codon optimized using Geneart's (Subsidiary of Thermo Fischer Scientific) service for improving expression in E. coli. The resulting gene was synthesized with the addition of ten histidine encoding codons C-terminally, along with flanking NdeI/XhoI restriction sites N-terminally and C-terminally, respectively (Gene ID: aquaporin_Oryza_sativa_Japonica). The synthetic gene fragment was digested with NdeI/XhoI restriction enzymes and ligated to NdeI/XhoI-digested and purified vector pUP1909 fragment. The resulting ligation mixture was transformed into Escherichia coli DH10B and kanamycin resistant transformants were selected on LB agar plates with kanamycin. Transformants were confirmed by sequencing of the genetic construct. Isolated vector DNA was subsequently transferred to the production host, Escherichia coli BL21.

In order to heterologously express aquaporin in E. coli, the production host was grown in minimal medium consisting of 30 g/L Glycerol, 6 g/L (NH4) 2HPO4, 3 g/L KH2PO4, 5 g/L NaCl, 0.25 g/L MgSO4·7H2O, 0.4 g/L Fe (III) citrate and 1 mL/L sterile filtered trace metal solution. The trace metal solution consisted of 1 g/L EDTA, 0.8 g/L CoC12·6H2O, 1.5 MnC12·4H20, 0.4 g/L CuC12·2H2O, 0.4 g/L H3BO3, 0.8 g/L Na2MoO4. 2H2O, 1.3 g/L Zn (CH3COO) 2·2H2O. After inoculation and overnight growth, additional 0.25 g/L MgSO4·7H2O was added.

E. coli was cultivated in 3L Applikon Bioreactors with ez-Control in a batch fermentation process. Protein production was induced by addition of IPTG to a final concentration of 0.5 mM at an optical density (OD 600 nm) of approximately 30. The culture was induced for approximately 24 hours and the bacterial cells were harvested with centrifugation at 5300 g for 20 min.

The pellets comprising the E. coli cells were resuspended in buffer (aqueous solution of the protease inhibitor PMSF and EDTA) and homogenized at 1000 bar in a Stansted nm-GEN 7575 homogenizer. The temperature was maintained around 10-15° C. The mixture was centrifuged at a maximum speed of 5300 g for 30 minutes. The pellet contains the membrane protein and the supernatant is discarded.

The pellet was resuspended in a 0.9% sodium chloride solution to obtain a total protein concentration of approximately 50 mg/ml. Solubilization of the membrane protein was performed by adding 28 L TRIS binding buffer and 4.5 liters 5% n-lauryl dimethylamine N-oxide (LDAO) to 5 L of the resuspended pellet material. At room temperature and gentle stirring, the mixture was allowed to incubate for 2 to 24 hours.

After the solubilization process, the mixture was centrifuged in 2 L containers at 5300 g for 90 minutes. The supernatant was recovered and the LDAO concentration was adjusted to 0.2% by addition of dilution buffer.

After solubilization and clarification, the protein was captured using IMAC and eluted in Elution buffer containing 1000 mM imidazole and 0.2% w/v LDAO. The elution fractions were analyzed by SDS Page and only revealed a single major band that migrated at 27 kDa, which corresponds to the size of aquaporin from Japanese rice. Furthermore, the result was confirmed by comparison to a negative control purification from E. coli transformed with an empty vector. The negative control resulted in no purified protein. Western blot analysis with antibodies (TaKaRa Bio) specific for the histidine-tag resulted as expected in a clear signal from the purified protein and no signal from the negative control confirming the origin of the purified protein as the histidine tagged membrane protein.

A stock solution was prepared by adjusting the protein concentration to 5 mg/ml by adding ice cold imidazole-free buffer containing 2% LDAO. Finally, the aquaporin stock solution was sterilized by filtration through 0.45 μM sterilized cup and stored at 4° C. in a refrigerator for use within a month or else stored at −80° C. in a freezer.

### 1.3: Production of Aquaporin Formulation

1. Prepare a 0.5% by weight Kolliphor® 15 HS (polyethylene glycol (15)-hydroxy stearate) (KHS) solution by dissolving 5 g KHS in 11 PBS (prepared by dissolving 8 g NaCl, 0.2 g KCl, 1.44 g Na2HPO4 and 0.24 g of KH2PO4 in 800 mL MiliQ purified H2O, adjusting the pH to 7.2 with HCl and completing the volume to 1 L).

2. Prepare a 0.05% by weight LDAO solution in PBS by dissolving 0.05 g LDAO in 100 mL PBS.

3. In the preparation vessel, weigh 0.5 g poly(2-methyloxazoline)-block-poly(dimethylsiloxane) diblock copolymer (PDMS₆₅PMOXA₂₄) per L of prepared formulation.

4. In the same preparation vessel weigh poly(2-methyloxazoline)-block-poly(dimethylsiloxane) diblock copolymer (PDMS₆₅PMOXA₃₂ to reach a concentration on 0.5 g/L of prepared formulation (1:1 weight ratio PDMS₆₅PMOXA₂₄ and PDMS₆₅PMOXA₃₂).

5. In the same preparation vessel, add poly(2-methyloxazoline)-block-poly(dimethylsiloxane)-block-poly-(2-methyloxazoline) triblock copolymer PMOXA₁₂PDMS₆₅PMOXA₁₂ to reach a concentration of 0.12 g/L of prepared formulation.

6. Add LDAO 0.05% prepared in step 2 in the proportion 100 mL/L of prepared formulation.

7. Add the bis(3-aminopropyl) terminated poly(dimethylsiloxane) having a molecular weight of 2500 Da to reach a final concentration of 0.1%.

8. Add aquaporin solution stock to reach a concentration of 5 mg/L of prepared formulation and a 1/400 protein:polymer ratio.

9. Add 3% by weight KHS solution prepared in step 1 to reach the desired volume of prepared formulation subtracting the volumes of LDAO, bis(3-aminopropyl) terminated poly(dimethylsiloxane), and aquaporin added in step 6 and 8.

10. Stir the mixture from step 9 overnight at 170 rotations per minute (not more than 20 hours) at room temperature to achieve the formulation.

11. Next morning take the prepared formulation obtained in the sequence of steps 1 to 10 and filter it through 200 nm pore size filters to sterilize it, put it in a closed sealed bottle and keep it at room temperature for not more than 12 months.

### 1.4: Production of TFC Layer on the Support Membrane

Aromatic polyamide TFC membranes were prepared through interfacial polymerization between MPD monomer in the aqueous phase and TMC monomer in organic Isopar™ E solvent. To prepare the aqueous solution, 5.1% wt methanesulfonic acid (MSA) was first dissolved in RO water, and the mixture was remained stirred. Once dissolved, 3.9% wt triethylamine (TEA) was added dropwise into the mixture to ensure the pH of the mixture after TEA addition was above 8. 3% wt M-Phenylenediamine (MPD) was then added into the mixture. 0.15% wt sodium lauryl sulfate (SLS) was added next after the IPA addition. Once all the SLS powder fully dissolved, 0.01% wt aquaporin formulation was added into the mixture and allowed to stir for at least 15 minutes prior to coating process.

a. Prepare an aqueous solution by mixing in DI water:
i 3% MPD
ii Sodium lauryl sulfate (SLS): 0.15%, Triethylamine (TEA): 3,9%; Methane sulphonic acid (70%): 5,1%, DI water: 87.84%.
iii 0.01% aquaporin formulation

Organic solution was prepared with dissolving 0.12% wt trimesoyl chloride (TMC) into the Isopar E and stirred. TFPTCS/TCPES stock solution was prepared by dissolving TFPTCS/TCPFPS into Isopar E, with 0.5% (w/w). Once the TMC is fully dissolved, TFPTCS/TCPFPS/TCPES stock solution was added to the organic solution with the final weight percentage of 0.0001-0.00037/0.0005-0.00025/0.0005-0.00037 in the organic solution.

b. Prepare an organic solution by mixing in Isopar E:
i 0.12% TMC, 0.15% TMC, 0.18% TMC or 0.21% TMC
ii pore forming agent in the amount indicate in the table below.

The polyamide layer coating was completed with a combination of customized roll-to-roll coating line and frame for curing, post treatment and final drying. PSF support membrane was loaded onto the unwinding roller of a coating line. The PSF membrane then passed through the slot die with a cloth underneath which aqueous solution was dispersed evenly onto the PSF support surface. Aqueous solution was remained on the PSF surface for 35 seconds and the excess solution was removed by a pressing wiper. The PSF surface then passed through organic soaking tank with 13 seconds soaking time. The coated membrane then was cut and clipped by the metal frame (210 mm×155 mm) and cured in a forced-convection oven set to 116° C. for 1 minute. The membrane frame was then removed from the oven and treated with hot citric acid solution (5% w/w) followed by hot RO water treatment at 50° C. for 2 minutes. This treatment was then repeated with a hotter citric acid solution and RO water at 65° C. for 2 minutes respectively. The membrane was then treated with sodium hypochlorite, 250 ppm, water, sodium bisulfite, 500 ppm, at 40° C. for 2 minutes, then treated with glycerin, 10% w/w at 40° C. for 1 minute. Lastly, the membrane was dried in oven at 91° C. for 20 seconds. The prepared membranes were cut into coupon sizes and stored in RO water prior to testing.

c. TFC formation:
Dipping support membrane in the aqueous solution for 30 seconds,
Drying the membrane with air gun at 1 bar,
Adding the organic solution for 30 seconds,
Drying the membrane with air gun at about 0.5 bar

### 1.5 Post-Treatments

The membranes were cured for 1 min at 116° C. and then the web was subjected to three temperature zones of 38° C., 66° C., and 116° C., respectively for 1 min.

Subsequently, the membranes were treated as indicated below:
5% Citric acid, 2 min at 50° C.
Water, 2 min at 50° C.
5% citric acid, 2 min at 65° C.
Water, 2 min 65° C.
NaOC1 250 ppm, 2 min at 40° C.
Water, 2 min at 40° C.
SBS 500 ppm, 2 min at 40° C.
10% glycerin, 1 min at 40° C.

Final drying: 20 seconds residence at 90.6° C. in a floatation dryer.

The membrane produced was subjected to soaking in 250 ppm NaCl for 30 min.

### 1.6 Table of Results of lab-Scale Membrane Production

| | | Pore | | |
|---|---|---|---|---|
| | | forming | | |
| Run | TMC | agent | Flux* | Rejection |
| Reference | 0.18% | 0.015% | 7.55 | 98.87 |
| | | TFPTCS^{¤} | | |
| 1 | 0.18% | 0.0155% | 7.2 | 98.69 |
| | | TCPES^{δ} | | |
| 2 | 0.18% | 0.0207% | 8.91 | 98.79 |
| | | TCPES^{δ} | | |
| 3 | 0.18% | 0.0259% | 9.75 | 98.88 |
| | | TCPES^{δ} | | |
| 4 | 0.15% | 0.0155% | 9.31 | 98.69 |
| | | TCPES^{δ} | | |

^{¤}Triflouropropyl trichloro silane
^{δ}Trichloro(phenethyl)silane 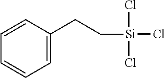 [SMILES: Cl[Si](Cl)(Cl)CCc1ccccc1]
^{#}Measured as GPD.

### 1.7 Flux & Salt Rejection Comparison in Pilot Scale

| | Flux | | | |
|---|---|---|---|---|
| | comparison | | | |
| | of | Flux | Rejection | |
| | 30 min and | Comparison | Comparison | |
| | overnight | with | with | SP |
| Membrane Batch | sampling | Baseline | Baseline | ratio |
| 0.12% TMC, | 8.60% | 13.6% | −0.09% | 1.89 |
| 0.00025% TFPTCS | | | | |
| 0.12% TMC, | 10.09% | 9.2% | −0.10% | 1.86 |
| 0.000125% TCPFPS | | | | |
| 0.12% TMC, | 8.00% | 3.5% | 0.17% | 1.74 |
| 0.00025% TCPES | | | | |

Conclusions: Membranes are responding both to TMC changes and TCPES changes. When TMC is fixed, the flux increases as a function of the concentration of TCPES. For the upper values of TCPES the flux values are 20-22% above the reference, while the rejection is maintained on the same level. When TCPES is fixed, a lower concentration of TMC results in a 23% higher flux than the reference, while the rejection is maintained on the same level.

TABLE 1.7

| | | Pore | | |
|---|---|---|---|---|
| | | forming | | |
| Run | TMC | agent | Flux* | Rejection |
| Reference | 0.18% | 0.015% | 7.47 | 97.89 |
| | | TFPTCS^{¤} | | |
| 1 | 0.18% | 0.0065% | 8.27 | 98.75 |
| | | TCPFPS^{δ2} | | |
| 2 | 0.18% | 0.0103% | 9.38 | 98.79 |
| | | TCPFPS^{δ2} | | |

^{δ2}Trichloro[3-(pentafluoro phenyl)]silane

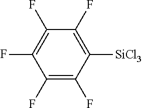

Conclusions: When TMC is fixed, the flux increases in dependence of the concentration of TCPES. For the uppermost value of TCPFPS the flux values are 26% above the reference, while the rejection is maintained on about the same level.

The various aspects and implementations have been described in conjunction with various embodiments herein. However, other variations to the disclosed embodiments can be understood and effected by those skilled in the art in practicing the claimed subject matter, from a study of the drawings, the disclosure, and the appended claims. In the claims, the word “comprising” does not exclude other elements or steps, and the indefinite article “a” or “an” does not exclude a plurality.

1-34. (canceled)

35. A process for preparing a semi-permeable membrane comprising a porous support membrane and a thin film composite (TFC) layer, comprising:
a. providing an aqueous phase comprising a polyfunctional amine monomer,
b. covering a surface of a porous support membrane with the aqueous phase,
c. providing an organic phase comprising a polyfunctional acyl halide monomer and a pore forming agent selected among the compounds represented by the general formula 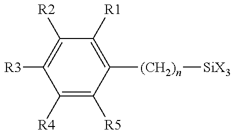
in which
R1, R2, R3, R4, R5 independently are selected from the group comprising H, a straight or branched C₁-C₆ lower alkyl, C₁-C₆ lower alkenyl or C₁-C₆ lower alkynyl, and a halogen selected from the group comprising F, Cl, Br, and I,
n is an integer selected among 0, 1, 2, 3, or 4,
X is a halogen selected among Cl, Br, and I,
d. covering the aqueous phase with the organic phase and allowing the polyfunctional amine monomer, the polyfunctional acyl halide monomer, and the pore forming agent to perform an interfacial polymerization reaction to form a polyamide TFC layer, wherein the pore forming agent is represented by the formula: 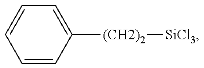
trichloro (phenethyl) silane (TCPES) or
wherein the pore forming agent is represented by the formula: 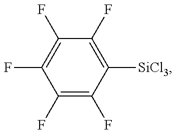
trichloro [3-(pentafluoro phenyl)] silane (TCPFPS).

36. The process for preparing a semi-permeable membrane according to claim 35, wherein the concentration of pore forming agent in the organic phase is in the range of 0.0001% by weight to 0.05% by weight.

37. The process for preparing a semi-permeable membrane according to claim 36, wherein the concentration of TCPES in the organic phase is comprised between 0.0001 wt % and 0.001 wt %.

38. The process for preparing a semi-permeable membrane according to claim 36, wherein the concentration of TCPES in the organic phase is comprised between 0.00025 wt % and 0.0005 wt %.

39. The process for preparing a semi-permeable membrane according to claim 36, wherein the concentration of TCPFPS in the organic phase is comprised between 0.0001 wt % and 0.001 wt %.

40. The process for preparing a semi-permeable membrane according to claim 36, wherein the concentration of TCPFPS in the organic phase is comprised between 0.000125 wt % and 0.0005 wt %.

41. The process for preparing a semi-permeable membrane according to claim 35, wherein between 0.1% wt and 0.25% wt acil halide is used in the organic phase.

42. The process for preparing a semi-permeable membrane according to claim 41, wherein 0.12% wt acil halide is used in the organic phase.

43. The process for preparing a semi-permeable membrane according to claim 35, wherein the organic phase further comprises a co-solvent selected from the group comprising ethyl formate, ethyl acetate, and diethyl ether.

44. The process for preparing a semi-permeable membrane according to claim 43, wherein the concentration of the co-solvent in the organic phase is 0.005 to 5%.

45. The process for preparing a semi-permeable membrane according to claim 35, wherein the aqueous phase further comprises aquaporins.

46. The process for preparing a semi-permeable membrane according to claim 41, wherein the main solvent of the organic phase comprises linear or branched C₅-C₁₂ alkanes.

47. The process for preparing a semi-permeable membrane according to claim 35, wherein polyethyleneimine (PEI) is included in the the polyamide TFC layer-forming reaction.

48. The process for preparing a semi-permeable membrane according to claim 47, wherein the polyethyleneimine (PEI) has an average molecular weight of between 2,000 Da to 10,000 Da.

49. The process for preparing a semi-permeable membrane according to claim 48, wherein the polyethyleneimine (PEI) has an average molecular weight of between 3,000 Da to 5,000 Da

50. A semi-permeable membrane prepared in accordance with the process for preparing a semi-permeable membrane of claim 35.

51. Use of the hollow fiber module or the spiral wound module comprising a semi-permeable membrane according to claim 50 for preparing a water permeate by reverse osmosis or for the concentration of a product solution by forward osmosis.

52. A semi-permeable membrane comprising a porous support membrane and a thin film composite (TFC) layer formed by interfacial polymerization of a polyfunctional amine monomer and a polyfunctional acyl halide monomer in the presence of a pore forming agent selected among the compounds represented by the general formula 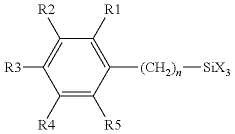
in which
R1, R2, R3, R4, R5 independently are selected from the group comprising H, a straight or branched C₁-C₆ lower alkyl, C₁-C₆ lower alkenyl or C₁-C₆ lower alkynyl, and a halogen selected from the group comprising F, Cl, Br, and I,
n is an integer selected among 0, 1, 2, 3, or 4,
X is a halogen selected among Cl, Br, and I, wherein the polyfunctional amine monomer, the polyfunctional acyl halide monomer, and the pore forming agent form a polyamide thin film composite (TFC) layer,
wherein the pore forming agent is represented by the formula: 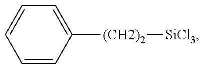
trichloro(phenethyl) silane (TCPES), or wherein the pore forming agent is represented by the formula: 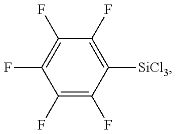
trichloro[3-(pentafluoro phenyl)] silane (TCPFPS).

53. The semi-permeable membrane according to claim 52, further comprising aquaporins.

54. The semi-permeable membrane according to claim 52, comprised in a hollow fiber module comprising a bundle of hollow fibers in a housing, wherein an inlet for passing a first solution is connected to the lumen of the hollow fibers in one end and an outlet is connected to the lumen in the other end, and an inlet is provided in the housing for passing a second solution to an outlet connected to the housing.
